(19) United States
(12) Patent Application Publication
(10) Pub. No.: US 2015/0118579 A1
(43) Pub. Date: Apr. 30, 2015

(54) Electrolytic Solution for Nonaqueous Electrolyte Batteries and Nonaqueous Electrolyte Battery Using the Same

(71) Applicant: Central Glass Co., Ltd., Ube-shi, Yamaguchi (JP)

(72) Inventors: Yuki Kondo, Kawagoe-shi (JP); Keita Nakahara, Shimonoseki-shi (JP); Satoshi Muramoto, Ube-shi (JP); Takayoshi Morinaka, Ube-shi (JP)

(21) Appl. No.: 14/403,761

(22) PCT Filed: May 29, 2013
(86) PCT No.: PCT/JP2013/064904

§ 371 Date: Nov. 25, 2014

(30) Foreign Application Priority Data
May 30, 2012 (JP) 2012-123186

(51) Int. Cl. H01M 10/0568; H01M 10/0525; H01M 10/0561

(52) U.S. Cl. CPC H01M 10/0568; H01M 10/0561; H01M 10/0525
USPC 429/338; 429/199; 429/342; 429/345; 429/341; 429/337; 252/62.2

(57) ABSTRACT

The present invention provides an electrolytic solution for a nonaqueous electrolyte battery and a nonaqueous electrolyte battery having excellent cycle characteristics and high-temperature storage characteristics without causing hydrolysis of a fluorine-containing lithium salt, such as LiPF₆, contained as a solute and containing a less amount of free fluorine ions, as well as a method of producing the electrolytic solution for a nonaqueous electrolyte battery. The electrolytic solution for a nonaqueous battery of the present invention includes a nonaqueous solvent and at least one fluorine-containing lithium salt as a solute and further includes an oxalato salt represented by Formula (1), wherein the content of a hexafluoro salt represented by Formula (2) is 150 mass ppm or less,

LiₓMF_{(6-2y)}(C₂O₄)_{y} (1)

LiₓMF₆ (2)
wherein M represents Fe, Sn, Si, Ge or Ti; x is 3 when M is Fe, and 2 when M is Sn, Si, Ge or Ti; and y is an integer of 1 to 3, wherein the content of the oxalato salt is 6500 mass ppm or less and the content of free fluorine ions is 50 mass ppm or less.

### TECHNICAL FIELD

The present invention relates to an electrolytic solution for a nonaqueous electrolyte battery constituting a nonaqueous electrolyte secondary battery having excellent cycle characteristics and storage stability, as well as a nonaqueous electrolyte battery using the same.

### BACKGROUND ART

Recently, electrical storage systems for information-related equipment or telecommunication equipment, i.e., electrical storage systems for equipment having a small size and requiring a high energy density, such as personal computers, video cameras, digital still cameras and cellular phones, as well as electrical storage systems for equipment having a large size and requiring a high electric power, such as electric automobiles, hybrid vehicles, auxiliary power supplies for fuel cell vehicles and electricity storages, have been attracting attentions. As candidates, nonaqueous electrolyte batteries, such as lithium-ion batteries lithium batteries, and lithium-ion capacitors, have been actively developed.

In general, such a nonaqueous electrolyte battery employs a nonaqueous electrolytic solution or a nonaqueous electrolytic solution solidified by a gelling agent as an ionic conductor. In nonaqueous electrolytic solutions, as a nonaqueous solvent, used is a solvent selected from aprotic ethylene carbonate, propylene carbonate, dimethyl carbonate, diethyl carbonate, ethyl methyl carbonate and the like, or a mixed solvent thereof; and as a solute, used is a fluorine-containing lithium salt such as LiPF₆, LiBF₄, LiN(CF₃SO₂)₂ or LiN(C₂F₅SO₂)₂.

When such a fluorine-containing lithium salt is used as a solute, however, free fluorine ions remain in the nonaqueous electrolytic solution as an impurity in the process of producing the nonaqueous electrolytic solution. Therefore, the internal resistance of the nonaqueous electrolyte battery is increased by repeating charge and discharge of the battery over a long period of time or by storing the battery at high temperature for a long time, resulting in a difficulty of discharge. The reason of this problem is believed as follows: the fluorine ions contained as an impurity in the nonaqueous electrolytic solution react with lithium on the anode to form a passive state film, such as LiF, on the surface of the anode, and the film increases the internal resistance. Furthermore, it is also believed that fluorine ions accelerate decomposition of the solute or the solvent or cause corrosion of the battery can material. For these reasons, while many nonaqueous electrolyte batteries have been already put into practical use, the durability is unsatisfactory in many uses. In particular, since the use thereof in an environment at 45° C. or more enhances the deterioration, the use thereof in an environment of high temperature over a long period of time, such as the use for automobiles, causes a problem, and a reduction in the concentration of fluorine ions remaining in a nonaqueous electrolytic solution has been demanded.

Japanese Patent No. 2983580 (Patent Literature 1) discloses the findings that the cycle characteristics and high-temperature storage characteristics of a nonaqueous electrolyte secondary battery can be improved by reducing the concentration of free fluorine ions to 50 mass ppm or less based on the total mass of the electrolytic solution. As a method for reducing the amount of fluorine ions contained in a nonaqueous electrolytic solution, Japanese Patent No. 2950924 (Patent Literature 2) proposes a method for reducing the concentration of fluorine ions by adding a nitrate or sulfate of a metal, such as Ca(NO₃)₂ or MgSO₄, to a nonaqueous electrolytic solution. However, in this method, the salt or oxide of a metal other than lithium added to a nonaqueous electrolytic solution is dissolved in the nonaqueous electrolytic solution. In a lithium secondary battery, the presence of a metal other than lithium in the electrolytic solution causes a problem of reducing the cycle characteristics and high-temperature storage characteristics of the battery. On the other hand, Japanese Patent No. 3077218 (Patent Literature 3) proposes a method for reducing the amount of hydrogen fluoride by adding a metal oxide such as BaO to a nonaqueous electrolytic solution; and Japanese Patent Laid-open Publication No. 2002-343364 (Patent Literature 4) proposes a method for removing hydrogen fluoride generated by the presence of moisture inside a battery by adding silicon dioxide to the cathode and/or the anode and/or the nonaqueous electrolytic solution inside the battery. However, it was conventionally known that the reaction of a metal oxide and hydrogen fluoride generates a metal fluoride and water. It was also known that an electrolyte containing a fluorine-containing lithium salt, such as LiPF₆ or LiBF₄, as the solute reacts with water to generate hydrogen fluoride. Thus, in these methods, the reaction of a metal oxide and hydrogen fluoride generates water, and the generated water hydrolyzes the electrolyte. It is therefore believed that the concentration of hydrogen fluoride increases again with time.

### PRIOR ART PUBLICATIONS

### Patent Literature

Patent Literature 1: Japanese Patent No. 2983580

Patent Literature 2: Japanese Patent No. 2950924

Patent Literature 3: Japanese Patent No. 3077218

Patent Literature 4: Japanese Patent Laid-open Publication No. 2002-343364

### SUMMARY OF INVENTION

### Technical Problem

The present invention provides an electrolytic solution for a nonaqueous electrolyte battery and a nonaqueous electrolyte battery having excellent cycle characteristics and high-temperature storage characteristics without causing hydrolysis of a fluorine-containing lithium salt, such as LiPF₆, contained as a solute and containing a less amount of free fluorine ions, as well as a method for producing the electrolytic solution for a nonaqueous electrolyte battery.

### Problem to Be Resolved by the Invention

The present inventors have found an electrolytic solution for a nonaqueous electrolyte battery comprising a nonaqueous solvent and at least one fluorine-containing lithium salt as a solute (hereinafter, also referred to as simply “nonaqueous electrolytic solution” or “electrolytic solution”) which can reduce the content of free fluorine ions and have excellent cycle characteristics and high-temperature storage characteristics by containing an oxalato salt having a specific composition, as well as a nonaqueous electrolyte battery using the electrolytic solution, and have eventually accomplished the present invention.

That is, the present invention relates to an electrolytic solution for a nonaqueous battery including a nonaqueous solvent and at least one fluorine-containing lithium salt as a solute and further including an oxalato salt represented by Formula (1) below, wherein the content of a hexafluoro salt represented by Formula (2) below is 150 mass ppm or less;

LiₓMF_{(6-2y)}(C₂O₄)_{y} (1)

LiₓMF₆ (2)

wherein M represents Fe, Sn, Si, Ge or Ti; x is 3 when M is Fe, and 2 when M is Sn, Si, Ge or Ti; and y is an integer of 1 to 3,

wherein the content of the oxalato salt is 6500 mass ppm or less and wherein the content of free fluorine ions is 50 mass ppm or less.

The oxalato salt is preferably at least one tris(oxalato) compound selected from the group consisting of Li₃Fe(C₂O₄)₃, Li₂Sn(C₂O₄)₃, Li₂Si(C₂O₄)₃, Li₂Ge(C₂O₄)₃, and Li₂Ti(C₂O₄)₃.

The solute is preferably at least one lithium salt selected from the group consisting of lithium hexafluorophosphate (LiPF₆), lithium tetrafluoroborate (LiBF₄), lithium bis(trifluoromethanesulfonyl)imide (LiN(CF₃SO₂)₂), lithium bis(fluorosulfonyl)imide (LiN(FSO₂)₂), lithium bis(pentafluoroethanesulfonyl)imide (LiN(C₂F₅SO₂)₂), lithium difluoro(oxalato)borate (LiBF₂(C₂O₄)), lithium difluoro(bis(oxalato))phosphate (LiPF₂(C₂O₄)₂) lithium tetrafluoro(oxalato)phosphate (LiPF₄(C₂O₄)) and lithium difluorophosphate (LiPO₂F₂).

The nonaqueous solvent is preferably at least one nonaqueous solvent selected from the group consisting of cyclic carbonates, chain carbonates, cyclic esters, chain esters, cyclic ethers, chain ethers, sulfur-containing nonaqueous solvents and ion liquids.

The present invention also relates to a nonaqueous electrolyte battery including at least a cathode, an anode, and an electrolytic solution for a nonaqueous electrolyte battery comprising a nonaqueous solvent and at least one fluorine-containing lithium salt as a solute, wherein the electrolytic solution for a nonaqueous electrolyte battery is as described above.

The present invention also relates to a method for producing the electrolytic solution for a nonaqueous electrolyte battery described above, comprising a step of preparing a solution containing 200 mass ppm or less of free fluorine ions by dissolving at least one fluorine-containing lithium salt as a solute in a nonaqueous solvent, and a reaction step of reacting the free fluorine ions in the solution with an oxalato salt represented by Formula (2) by adding the oxalato salt to the solution.

The production method can prepare an electrolytic solution for a nonaqueous electrolyte battery containing 150 mass ppm or less of the hexafluoro salt represented by Formula (2), 6500 mass ppm or less of the oxalato salt, and 50 mass ppm or less of free fluorine ions.

In the production method, the oxalato salt is preferably added to the solution such that the molar ratio of the oxalato salt to the free fluorine ions is 0.02 to 2.0.

The production method preferably further includes a filtration step of removing the solid content of a reaction product.

The oxalato salt is preferably at least one tris(oxalato) compound selected from the group consisting of Li₃Fe(C₂O₄)₃, Lie Sn(C₂O₄)₃, Li₂Si(C₂O₄)₃, Li₂Ge(C₂O₄)₃ and Li₂Ti(C₂O₄)₃.

In the production method, the solute is preferably at least one lithium salt selected from the group consisting of lithium hexafluorophosphate (LiPF₆), lithium tetrafluoroborate (LiBF₄), lithium bis(trifluoromethanesulfonyl)imide (LiN(CF₃SO₂)₂), lithium bis(fluorosulfonyl)imide (LiN(FSO₂)₂), lithium bis(pentafluoroethanesulfonyl)imide (LiN(C₂F₅SO₂)₂), lithium difluoro(oxalato)borate (LiBF₂(C₂O₄)), lithium difluoro(bis(oxalato))phosphate (LiPF₂(C₂O₄)₂), lithium tetrafluoro(oxalato)phosphate (LiPF₄(C₂O₄)) and lithium difluorophosphate(LiPO₂F₂).

In the production method, the nonaqueous solvent is preferably at least one nonaqueous solvent selected from the group consisting of cyclic carbonates, chain carbonates, cyclic esters, chain esters, cyclic ethers, chain ethers, sulfur-containing nonaqueous solvents and ion liquids.

### Effects by the Invention

The present invention can provide an electrolytic solution for a nonaqueous electrolyte battery and a nonaqueous electrolyte battery having excellent cycle characteristics and high-temperature storage characteristics without causing hydrolysis of a fluorine-containing lithium salt, such as LiPF₆, contained as a solute and containing a less amount of free fluorine ions, as well as a method for producing the electrolytic solution for a nonaqueous electrolyte battery.

### BRIEF DESCRIPTION OF DRAWINGS

FIG. 1 is a graph showing discharge capacity retention rates after 500 cycles in Examples 1-1 to 1-66 and Comparative Examples 1-1 to 1-6.

FIG. 2 is a graph showing discharge capacity retention rates after 10 days storage in Examples 1-1 to 1-66 and Comparative Examples 1-1 to 1-6.

FIG. 3 is a graph showing discharge capacity retention rates after 500 cycles in Examples 1-67 to 1-74, Comparative Examples 1-7 to 1-10, Examples 2-1 to 2-12, Comparative Examples 2-1 to 2-6, Examples 3-1 to 3-8, Comparative Examples 3-1 to 3-4, Examples 4-1 to 4-4, and Comparative Examples 4-1 and 4-2.

FIG. 4 is a graph showing discharge capacity retention rates after 10 days storage in Examples 1-67 to 1-74, Comparative Examples 1-7 to 1-10, Examples 2-1 to 2-12, Comparative Examples 2-1 to 2-6, Examples 3-1 to 3-8, Comparative Examples 3-1 to 3-4, Examples 4-1 to 4-4, and Comparative Examples 4-1 and 4-2.

### DESCRIPTION OF EMBODIMENTS

The present invention will now be described in detail below. The present electrolytic solution for a nonaqueous electrolyte battery comprising a nonaqueous solvent and at least one fluorine-containing lithium salt as a solute further comprises an oxalato salt represented by Formula (1) such that the content of a hexafluoro salt represented by Formula (2) is 150 mass ppm or less, the content of the oxalato salt is 6500 mass ppm or less, and the content of free fluorine ions is 50 mass ppm or less. The electrolytic solution for a nonaqueous electrolyte battery can optionally contain another well-known additive. In the present electrolytic solution for a nonaqueous electrolyte battery, the oxalato salt reacts with free fluorine ions contained in the electrolytic solution to generate the hexafluoro salt represented by Formula (2), which does not adversely affect the battery performance, to reduce the amount of free fluorine ions without causing hydrolysis of the fluorine-containing lithium salt, such as LiPF₆, contained as a solute. As a result, the battery performance is prevented from being deteriorated by fluorine ions, and the cycle characteristics and the high-temperature storage characteristics of the nonaqueous electrolyte battery including the nonaqueous electrolytic solution of the present invention can be improved. In addition, the hexafluoro salt can be removed from the nonaqueous electrolytic solution by a filtration step, but if the amount is small, the hexafluoro salt does not adversely affect the battery performance even if it is not removed.

Each component of the electrolytic solution for a nonaqueous electrolyte battery of the present invention will now be described in detail. The present invention relates to an electrolytic solution for a nonaqueous battery containing a nonaqueous solvent and at least one fluorine-containing lithium salt as a solute. The electrolytic solution further contains an oxalato salt represented by Formula (1) such that the content of a hexafluoro salt represented by Formula (2) is 150 mass ppm or less, the content of the oxalato salt is 6500 mass ppm or less, and the content of free fluorine ions is 50 mass ppm or less. An oxalato salt having a larger number of oxalic acid groups can treat a larger number of fluorine ions per 1 mol of the oxalato salt and can achieve the treatment with a smaller amount of the oxalato salt. Accordingly, preferred oxalato salts are tris(oxalato) salts such as Li₃Fe(C₂O₄)₃, Liz Sn(C₂O₄)₃, Liz Si(C₂O₄)₃, Li₂Ge(C₂O₄)₃ and Li₂Ti(C₂O₄)₃. If the content of free fluorine ions in the electrolytic solution for a nonaqueous electrolyte battery is higher than 50 mass ppm, the internal resistance of the battery is increased by repeating charge and discharge of the nonaqueous electrolyte battery including the electrolytic solution over a long period of time or by storing the battery at high temperature for a long time, resulting in a difficulty of discharge (deterioration in cycle characteristics and high-temperature storage characteristics). In contrast, a content of the fluorine ions of 50 mass ppm or less can provide excellent cycle characteristics and high-temperature storage characteristics. The content of the fluorine ions is more preferably 45 mass ppm or less and most preferably 40 mass ppm or less.

The hexafluoro salt contained in the electrolytic solution for a nonaqueous electrolyte battery is generated by the reaction of the oxalato salt with fluorine ions. The content of the hexafluoro salt is 150 mass ppm or less so that the hexafluoro salt can be dissolved in the electrolytic solution. If the content is higher than 150 mass ppm, the nonaqueous electrolyte battery produced using the electrolytic solution has a risk of precipitating the hexafluoro salt in the inside of the nonaqueous electrolyte battery to prevent the charge and discharge of the battery. A content of 140 mass ppm or less hardly causes the precipitation of the hexafluoro salt in the electrolytic solution even at low temperature and is therefore more preferred. Even if the content is higher than 150 mass ppm, the content of the hexafluoro salt in the electrolytic solution can be reduced to 150 mass ppm or less by removing the solid of the hexafluoro salt by filtration of the electrolytic solution.

If the content of the oxalato salt contained in the electrolytic solution for a nonaqueous electrolyte battery is higher than 6500 mass ppm, the cycle characteristics and high-temperature storage characteristics of the resulting electrolytic solution are low. The oxalato salt reacts with fluorine ions to reduce the concentration of the fluorine ions. There may be a case in which all of the oxalato salt is consumed by the reaction and the finally obtained electrolytic solution for a nonaqueous electrolyte battery does not contain the oxalato salt. However, because of the easiness of sufficiently reducing the final number of free fluorine ions, i.e., because of the easiness of reducing the content of free fluorine ions in the electrolytic solution to 50 mass ppm or less, the resulting electrolytic solution for a nonaqueous electrolyte battery preferably contains the oxalato salt. Accordingly, the content of the oxalato salt in the electrolytic solution for a nonaqueous electrolyte battery is preferably 10 to 6500 mass ppm and more preferably 25 to 6000 mass ppm.

The molar ratio of the addition amount of the oxalato salt to the free fluorine ions in a solution containing a nonaqueous solvent, the solute described above, and 200 mass ppm or less of the free fluorine ions is within a range of 0.02 to 2.0, preferably 0.17 to 2.0, and most preferably 0.2 to 1.5. A molar ratio of the oxalato salt to the fluorine ions of less than 0.02 tends to insufficiently reduce the number of the free fluorine ions and is therefore undesirable. In order to sufficiently reduce the number of the fluorine ions, the molar ratio of the addition amount of the oxalato salt to the fluorine ions is preferably 0.17 or more and more preferably 0.2 or more. The increase in the addition amount of the oxalato salt increases the effect of reducing the concentration of fluorine ions, but a molar ratio of higher than 2.0 has a risk that the excessive amount of the oxalato salt adversely affects the battery performance. In addition, an increase in the addition amount of the oxalato salt increases the raw material cost. Accordingly, the molar ratio of the addition amount to the fluorine ions is preferably 2.0 or less and more preferably 1.5 or less. The reaction step of adding an oxalato salt to the solution described above and reacting the oxalato salt with free fluorine ions in the solution is preferably performed with stirring of the solution. The temperature of the solution during the reaction is not particularly limited and is preferably −20° C. to 80° C. and more preferably 0° C. to 60° C.

In order to produce an electrolytic solution, in the solution prepared using a nonaqueous solvent and the above-mentioned solute (electrolyte), the sum of the amount of the free fluorine ions remaining in the solute and the amount of fluorine ions newly generated by hydrolysis of the solute by the moisture contaminated in the step of preparing the solution is usually about 100 mass ppm based on the total amount of the solution. As a rare case, the concentration of fluorine ions in the solution is increased to about 200 mass ppm by contamination of a large amount of moisture from the outside. The concentration of fluorine ions may be further increased to higher than 200 mass ppm by further contamination of a large amount of moisture. When such a high concentration of fluorine ions is treated with an oxalato salt such as Li₃Fe(C₂O₄)₃, a large amount of solid content such as a hexafluoro salt, Li₃FeF₆, is generated as a reaction product. Consequently, in order to obtain only a nonaqueous electrolytic solution, it is necessary to remove the solid content by filtration. However, since the filterability of a nonaqueous electrolytic solution containing a large amount of the solid content is very low, the productivity of the nonaqueous electrolytic solution is significantly reduced. It is therefore not desirable to reduce the concentration of fluorine ions by adding an oxalate salt to the solution containing a nonaqueous solvent and the solute and also containing free fluorine ions in an amount higher than 200 mass ppm. On the other hand, even in a solution containing mass ppm or less of fluorine ions, the amount of fluorine ions can be further reduced by adding an oxalato salt to the solution. The filtration step can be performed with, for example, a pressure filter, vacuum filter or filter press using a filter cloth or cartridge filter; a precipitator or filtration separator by centrifugation; or a cross-flow filter using an ultrafilter. The filterability is judged by the average amount (kg/(m²·sec)) of the nonaqueous electrolytic solution that can be filtrated by filtration using a filter with a filtration area of 1 m² for 1 hour. A filtration rate of 1 kg/(m²·sec) or more is preferred, and 3 kg/(m²·sec) or more is further preferred. Hereinafter, the average amount of the nonaqueous electrolytic solution that can be filtrated for 1 hour from the start of the filtration may be referred to as simply “filterability.” The resulting nonaqueous electrolytic solution after the filtration may be further subjected to, for example, concentration, dilution with a nonaqueous solvent, or addition of an additive described below to the electrolytic solution.

The nonaqueous solvent contained in the present electrolytic solution for a nonaqueous electrolyte battery may be any appropriate nonaqueous solvent without any specific limitation. Examples of the solvent include cyclic carbonates such as propylene carbonate, ethylene carbonate and butylene carbonate; chain carbonates such as diethyl carbonate, dimethyl carbonate and ethyl methyl carbonate; cyclic esters such as γ-butyrolactone and γ-valerolactone; chain esters such as methyl acetate and methyl propionate; cyclic ethers such as tetrahydrofuran, 2-methyltetrahydrofuran and dioxane; chain ethers such as dimethoxyethane and diethyl ether; and sulfur-containing nonaqueous solvents such as dimethyl sulfoxide and sulfolane. Although the category is different from the nonaqueous solvent, ion liquids can also be used. In the present invention, these nonaqueous solvents may be used alone or in appropriate combination at an appropriate ratio depending on the use. Among these solvents, particularly preferred are propylene carbonate, ethylene carbonate, diethyl carbonate, dimethyl carbonate and ethyl methyl carbonate, from the viewpoint of the electrochemical stability against redox and the chemical stability against heat and a reaction with the solute.

The solute contained in the present electrolytic solution for a nonaqueous electrolyte battery may be any appropriate fluorine-containing lithium salt without any specific limitation. Examples of the solute include electrolyte lithium salts such as LiPF₆, LiBF₄, LiAsF₆, LiSbF₆, LiCF₃SO₃, LiN(CF₃SO₂)₂, LiN(FSO₂)₂, LiN(C₂F₅SO₂)₄, LiN(CF₃SO₂) (C₄F₉SO₂), LiC(CF₃SO₄)₃, LiPF₃(C₃F₇)₃, LiB(CF₃)₄, LiBF₃(C₂F₅), LiBF₂(C₂O₄), LiPF₂(C₂O₄)₂, LiPF₄(C₂O₄) and LiPO₂F₂. These solutes may be used alone or in appropriate combination at an appropriate ratio depending on the use. In particular, LiPF₆, LiBF₄, LiN(CF₃SO₂)₂, LiN(FSO₂)₂, LiN(C₂F₅SO₂)₂, LiBF₂(C₂O₄), LiPF₂(C₂O₄)₂, LiPF₄(C₂O₄) and LiPO₂F₂ are preferred on the basis of, for example, the energy density, output characteristics, and life span as a battery. Furthermore, an electrolyte lithium salt such as LiClO₄ or LiB(C₂O₄)₄, may be further added to the electrolytic solution as a solute in addition to the above-mentioned solute.

These solutes may be used at any concentration without any particular limitation. The lower limit is 0.5 mol/L or more, preferably 0.7 mol/L or more, and most preferably 0.9 mol/L or more; and the upper limit is 2.5 mol/L or less, preferably 2.0 mol/L or less, and most preferably 1.5 mol/L or less. A concentration of less than 0.5 mol/L tends to reduce the cycle characteristics and output characteristics of the nonaqueous electrolyte battery due to a reduction in ionic conductance. In contrast, a concentration of higher than 2.5 mol/L tends to reduce the ionic conductance due to an increase in the viscosity of the electrolytic solution for a nonaqueous electrolyte battery and has a risk of reducing the cycle characteristics and output characteristics of the nonaqueous electrolyte battery.

The fundamental components of the present electrolytic solution for a nonaqueous electrolyte battery have been described above. The electrolytic solution for a nonaqueous electrolyte battery of the present invention may further contain additives that are usually used in electrolytic solutions at appropriate ratios that do not impair the gist of the present invention. Examples of the additives include compounds having overcharge preventing effect, anode film forming effect and cathode protecting effect, such as cyclohexylbenzene, biphenyl, t-butylbenzene, vinylene carbonate, vinylethylene carbonate, difluoroanisole, fluoroethylene carbonate, propane sultone and dimethylvinylene carbonate. The present electrolytic solution for a nonaqueous electrolyte battery can also be used by being coagulated with a gelling agent or a crosslinked polymer, as used in a nonaqueous electrolyte battery called a lithium polymer battery.

The constitution of the nonaqueous electrolyte battery of the present invention will now be described. The nonaqueous electrolyte battery of the present invention is characterized by the use of the above-described electrolytic solution for a nonaqueous electrolyte battery of the present invention. The other constitutional members are those used in common nonaqueous electrolyte batteries. That is, the battery comprises a cathode and an anode, capable of occluding and releasing lithium ions, an electric collector, a separator, a container and the like.

The anode material is not particularly limited, and examples thereof include lithium metal, alloys or intermetallic compounds of lithium and other metals, various carbon materials, artificial graphite, natural graphite, metal oxides, metal nitrides, tin (simple substance), tin compounds, silicon (simple substance), silicon compounds, activated carbon and conductive polymers.

The cathode material is not particularly limited, and examples thereof in lithium batteries and lithium ion batteries include lithium-containing transition metal complex oxides, such as LiCoO₂, LiNiO₂, LiMnO₂ and LiMn₂O₄; these lithium-containing transition metal complex oxides having a mixture of a plurality of transition metals such as Co, Mn, and Ni; these lithium-containing transition metal complex oxides having a metal, other than the transition metals, substituted for a part of the transition metal; phosphate compounds of transition metals, such as LiFePO₄, LiCoPO₄ and LiMnPO₄ called olivine; oxides such as TiO₂, V₂O₅ and MoO₃; sulfides such as TiS₂ and FeS; conductive polymers such as polyacetylene, polyparaphenylene, polyaniline, and polypyrrole; activated carbon; polymers generating radicals; and carbon materials.

The cathode and anode materials can be formed into electrode sheets using a conductive material, such as acetylene black, Ketjen black, carbon fibers or graphite, and a binder, such as polytetrafluoroethylene, polyvinylidene fluoride or a SBR resin.

The separator for preventing the contact between the cathode and the anode can be nonwoven fabric or a porous sheet made of, for example, polypropylene, polyethylene, paper or glass fibers.

Each element described above is assembled into a nonaqueous electrolyte battery having a shape of, for example, a coin, a cylinder, a square, or an aluminum lamination sheet.

### EXAMPLES

The present invention will now be specifically described by way of the following examples, but is not limited to those examples.

### Example 1-1

Using a mixed solvent of ethylene carbonate with ethyl methyl carbonate at a volume ratio of 1:2 as a nonaqueous solvent, LiPF₆ was dissolved as a solute in the nonaqueous solvent, to give a solution with a concentration of 1.0 mol/L of the solute. Hydrogen fluoride was added to the electrolytic solution wherein the fluorine ion concentration thereof had been controlled to 5 mass ppm by passing the solution through a column filled with an ion-exchange resin, so as to control the concentration of fluorine ions to 30 mass ppm. By the process described above, a solution containing 200 mass ppm or less of free fluorine ions and a fluorine-containing lithium salt as a solute in a nonaqueous solvent was prepared. Hereinafter, a solution having a fluorine ion concentration controlled as described above, i.e., a solution before a reduction in a fluorine ion concentration by an oxalato salt, may be referred to as “initial solution”.

Subsequently, an oxalato salt, Li₃Fe(C₂O₄)₃, was added to the initial solution at a molar ratio of Li₃Fe(C₂O₄)₃ to fluorine ions of 0.01. The solution was stirred at 25° C. for 1 hour and was then subjected to pressure filtration at 0.4 MPa through a polytetrafluoroethylene filter having a pore size of 0.5 μm to obtain an electrolytic solution for a nonaqueous battery. At this stage, the filterability was 3 kg/(m²·sec), which was satisfactory filterability. Furthermore, the concentrations of fluorine ions in the electrolytic solution for a nonaqueous electrolyte battery measured at about 1 hour and about 24 hours after the filtration were both 27 mass ppm. Thus, the concentration of fluorine ions was sufficiently reduced, and the reduced concentration was stably maintained. The amounts of moisture in the electrolytic solution for a nonaqueous electrolyte battery measured at about 1 hour and about 24 hours after the filtration were both low, 4 mass ppm. The concentrations of fluorine ions were measured by ion chromatography (ICS-3000 (column: Ion Pac AG-17/AS-14), manufactured by Dionex Corporation). The amounts of moisture were measured with an apparatus for measuring trace amounts of moisture (Karl-Fischer moisture meter MKC-610, manufactured by Kyoto Electronics Manufacturing Co., Ltd.). The concentrations of Li₃FeF₆ and Li₃Fe(C₂O₄)₃ in the electrolytic solutions were determined as follows. The concentration of Li₃FeF₆ in the electrolytic solution was determined by ¹⁹F NMR. Then, the sum of concentrations of Fe in Li₃FeF₆ and Li₃Fe(C₂O₄)₃ was measured by ICP-AES (ICPS8100CL, manufactured by Shimadzu Corporation). The difference between the sum of the concentrations of Fe and the concentration of Fe derived from Li₃FeF₆ calculated from the concentration of Li₃FeF₆ determined by NMR was defined as the concentration of Fe derived from Li₃Fe(C₂O₄)₃, and the concentration of Li₃Fe(C₂O₄)₃ was calculated from this value. As a result, the electrolytic solution had a Li₃FeF₆ concentrations of 3 mass ppm and a Li₃Fe(C₂O₄)₃ concentration of less than minimum limit of determination. The results are shown in Table 1. The concentrations of Li₂MF₆ and Li₂M(C₂O₄)₃ (M=Sn, Si, Ge or Ti) in Comparative Examples and Examples described below were similarly measured by NMR and ICP-AES. In the electrolytic solutions for a nonaqueous electrolyte battery prepared in all Examples and Comparative Examples described below, except for Comparative Example 1-6, the concentrations of fluorine ions at about 1 hour and about hours after filtration did not substantially have a difference therebetween and were stable as in Example 1-1. In each electrolytic solution for a nonaqueous electrolyte battery prepared in all Examples and Comparative Examples described below, except Comparative Example 1-5, the amounts of moisture at about 1 hour and about 24 hours after filtration did not substantially have a difference therebetween and were stable as in Example 1-1.

A cell was prepared using the prepared electrolytic solutions, LiCoO₂ as a cathode material and graphite as an anode material, and then the cycle characteristics and high-temperature storage characteristics of the cell were actually evaluated. The test cell was produced as follows.

Ninety parts by mass of LiCoO₂ powder was mixed with 5 parts by mass of polyvinylidene fluoride (PVDF) as a binder and 5 parts by mass of acetylene black as a conductive material. N-Methylpyrrolidone was added to the mixture to form a paste. The paste was applied onto aluminum foil, followed by drying it to give a cathode body for tests. Separately, 90 parts by mass of a graphite powder was mixed with 10 parts by mass of polyvinylidene fluoride (PVDF) as a binder. N-Methylpyrrolidone was added to the mixture to form a slurry. This slurry was applied onto copper foil, followed by drying at 150° C. for 12 hours to give an anode body for tests. A polyethylene separator was impregnated with the electrolytic solution to assemble a 50 mAh cell of an aluminum laminated exterior.

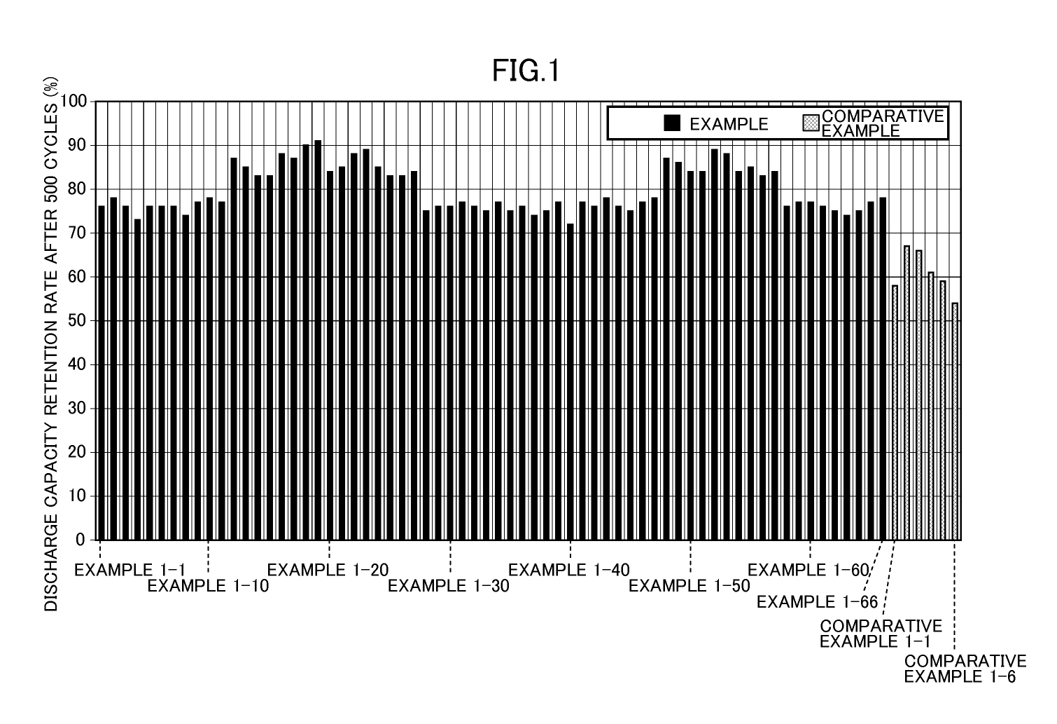

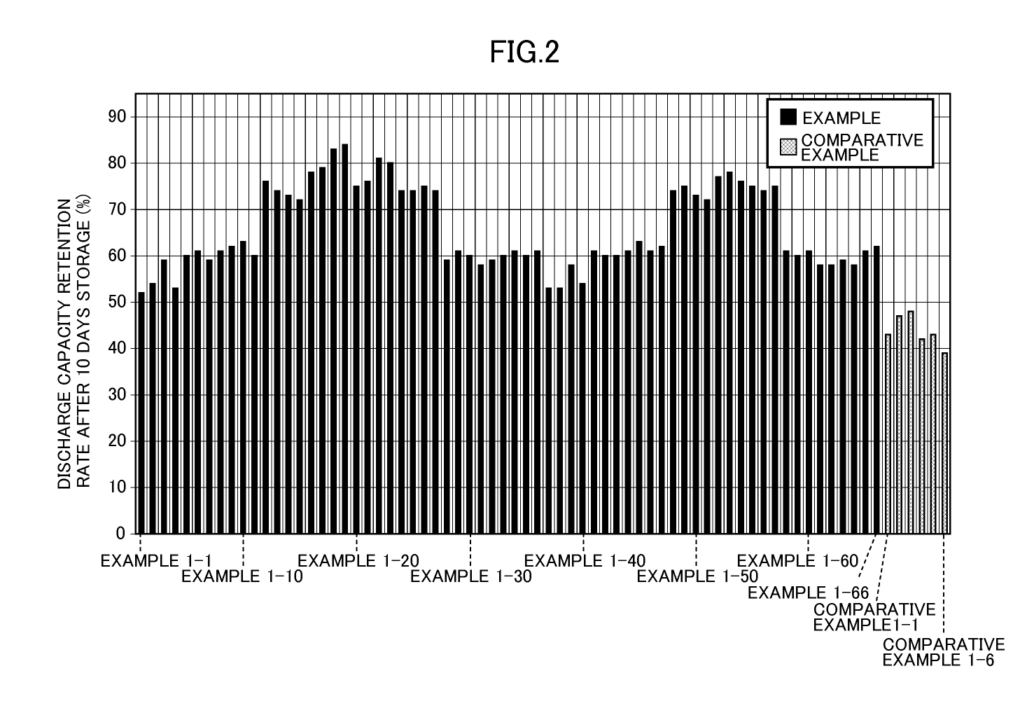

The cell produced by the method described above was subjected to a charge-discharge test at an environmental temperature of 60° C. to evaluate the cycle characteristics and high-temperature storage characteristics. The charge and discharge were both performed at a current density of 0.35 mA/cm²; and a charge-discharge cycle of charging up to 4.2 V, retention at 4.2 V for 1 hour and discharging down to 3.0 V was repeated. The degree of deterioration of the cell was evaluated by the discharge capacity retention rate after 500 cycles (evaluation of cycle characteristics). Separately, a storage stability test was performed at an environmental temperature of 60° C. That is, the cell was fully charged at a current density of 0.35 mA/cm² at room temperature and was then stored at an environmental temperature of 60° C. for 10 days. Subsequently, the cell was discharged at a current density of 0.35 mA/cm² at room temperature. The degree of deterioration of the cell was evaluated by the discharge capacity retention rate after 10 days storage (evaluation of high-temperature storage characteristics). The discharge capacity retention rates were determined by the following equations. The results are shown in Table 2 and FIGS. 1 and 2.

<Discharge Capacity Retention Rate after 500 Cycles>

Discharge capacity retention rate(%)=(discharge capacity after 500 cycles/initial discharge capacity)×100,

<Discharge Capacity Retention Rate after 10 Days Storage>

Discharge capacity retention rate(%)=(discharge capacity after 10 days storage/initial discharge capacity)×100.

TABLE 1

| | | | Concen- | | | | | Electrolytic solution for a nonaqueous | | |
|---|---|---|---|---|---|---|---|---|---|---|
| | | | tration of | | | | | electrolyte battery | | |
| | | | fluorine | | Salt or | | | Con- | Concen- | Concentration |
| | | | ions in | | oxide of | Fluorine | Filter- | centration | tration of | of |
| | Nonaqueous | | initial | | metal | ion:oxalato | ability | of | oxalato | fluorine ions at |
| | electrolytic | | solution | | other | salt in initial | [kg/ | hexafluoro | salt | about 1 hr after |
| | solution | | [mass | Oxalato | than | solution | (m² · | salt [mass | [mass | filtration [mass |
| | No. | Solute | ppm] | salt | lithium | [molar ratio] | sec)] | ppm] | ppm] | ppm] |
| Example 1-1 | 1-1 | LiPF₆ | 30 | Li₃Fe(C₂O₄)₃ | None | 1:0.01 | 3 | 3 | N.D. | 27 |
| Example 1-2 | 1-2 | | 30 | | | 1:0.02 | 9 | 6 | N.D. | 25 |
| Example 1-3 | 1-3 | | 30 | | | 1:0.2 | 9 | 42 | 18 | 8 |
| Example 1-4 | 1-4 | | 50 | | | 1:0.02 | 9 | 9 | N.D. | 44 |
| Example 1-5 | 1-5 | | 50 | | | 1:0.2 | 9 | 70 | 27 | 7 |
| Example 1-6 | 1-6 | | 50 | | | 1:2.0 | 8 | 67 | 1606 | 9 |
| Example 1-7 | 1-7 | | 100 | | | 1:0.2 | 6 | 132 | 54 | 9 |
| Example 1-8 | 1-8 | | 100 | | | 1:1.0 | 5 | 128 | 1442 | 6 |
| Example 1-9 | 1-9 | | 100 | | | 1:2.0 | 6 | 120 | 3189 | 10 |
| Example 1-10 | 1-10 | | 100 | | | 1:3.0 | 4 | 118 | 4938 | 9 |
| Example 1-11 | 1-11 | | 100 | | | 1:0.2 | — | 137 | 56 | 9 |
| Example 1-12 | 1-12 | LiPF₆, | 150 | Li₂Sn(C₂O₄)₃ | | 1:0.2 | 7 | 135 | 94 | 9 |
| Example 1-13 | 1-13 | LiBF₂(C₂O₄) | 150 | | | 1:2.0 | 6 | 119 | 5724 | 8 |
| Example 1-14 | 1-14 | LiPF₆, | 150 | | | 1:0.2 | 7 | 134 | 91 | 7 |
| Example 1-15 | 1-15 | LiBF₄ | 150 | | | 1:2.0 | 7 | 117 | 5715 | 9 |
| Example 1-16 | 1-16 | LiPF₆, | 150 | | | 1:0.2 | 6 | 129 | 96 | 7 |
| Example 1-17 | 1-17 | LiB(C₂O₄)₂ | 150 | | | 1:2.0 | 7 | 109 | 5731 | 7 |
| Example 1-18 | 1-18 | LiPF₆, | 150 | Li₂Si(C₂O₄)₃ | | 1:0.2 | 7 | 129 | 80 | 8 |
| Example 1-19 | 1-19 | LiPF₂(C₂O₄)₂ | 150 | | | 1:2.0 | 7 | 107 | 4427 | 7 |
| Example 1-20 | 1-20 | LiPF₆, | 150 | | | 1:0.2 | 6 | 131 | 82 | 9 |
| Example 1-21 | 1-21 | LiPO₂F₂ | 150 | | | 1:2.0 | 7 | 112 | 4429 | 8 |
| Example 1-22 | 1-22 | LiPF₆, | 150 | | | 1:0.2 | 6 | 129 | 79 | 9 |
| Example 1-23 | 1-23 | LiPF₄(C₂O₄) | 150 | | | 1:2.0 | 6 | 110 | 4427 | 8 |
| Example 1-24 | 1-24 | LiPF_{6 ,} | 150 | Li₂Ge(C₂O₄)₃ | | 1:0.2 | 7 | 132 | 83 | 7 |
| Example 1-25 | 1-25 | LiN(CF₃SO₂)₂ | 150 | | | 1:2.0 | 6 | 111 | 5066 | 9 |
| Example 1-26 | 1-26 | LiPF₆, | 150 | Li₂Ti(C₂O₄)₃ | | 1:0.2 | 6 | 131 | 76 | 9 |
| Example 1-27 | 1-27 | LiN(FSO₂)₂ | 150 | | | 1:2.0 | 7 | 114 | 4708 | 8 |

TABLE 2

| | Nonaqueous | | | | |
|---|---|---|---|---|---|
| | electrolytic | Cathode active | Anode active | Discharge capacity retention | Discharge capacity retention rate |
| | solution No. | material | material | rate after 500 cycles [%] | after 10 days storage [%] |
| Example 1-1 | 1-1 | LiCoO₂ | Graphite | 76 | 52 |
| Example 1-2 | 1-2 | | | 78 | 54 |
| Example 1-3 | 1-3 | | | 76 | 59 |
| Example 1-4 | 1-4 | | | 73 | 53 |
| Example 1-5 | 1-5 | | | 76 | 60 |
| Example 1-6 | 1-6 | | | 76 | 61 |
| Example 1-7 | 1-7 | | | 76 | 59 |
| Example 1-8 | 1-8 | | | 74 | 61 |
| Example 1-9 | 1-9 | | | 77 | 62 |
| Example 1-10 | 1-10 | | | 78 | 63 |
| Example 1-11 | 1-11 | | | 77 | 60 |
| Example 1-12 | 1-12 | | | 87 | 76 |
| Example 1-13 | 1-13 | | | 85 | 74 |
| Example 1-14 | 1-14 | | | 83 | 73 |
| Example 1-15 | 1-15 | | | 83 | 72 |
| Example 1-16 | 1-16 | | | 88 | 78 |
| Example 1-17 | 1-17 | | | 87 | 79 |
| Example 1-18 | 1-18 | | | 90 | 83 |
| Example 1-19 | 1-19 | | | 91 | 84 |
| Example 1-20 | 1-20 | | | 84 | 75 |
| Example 1-21 | 1-21 | | | 85 | 76 |
| Example 1-22 | 1-22 | | | 88 | 81 |
| Example 1-23 | 1-23 | | | 89 | 80 |
| Example 1-24 | 1-24 | | | 85 | 74 |
| Example 1-25 | 1-25 | | | 83 | 74 |
| Example 1-26 | 1-26 | | | 83 | 75 |
| Example 1-27 | 1-27 | | | 84 | 74 |

### Examples 1-2 to 1-10

The concentration of fluorine ions was reduced as in Example 1-1 except that the concentration of fluorine ions in the initial solution and the molar ratio of fluorine ions in the initial solution to Li₃Fe(C₂O₄)₃ added to the initial solution were changed as shown in Table 1. Table 1 shows the filterability of the solution after the reduction in concentration of fluorine ions and the concentrations of Li₃FeF₆, Li₃Fe(C₂O₄)₃, and fluorine ions in the resulting electrolytic solution for a nonaqueous electrolyte battery. The evaluation results of the cycle characteristics and high-temperature storage characteristics of each battery including the electrolytic solution for a nonaqueous electrolyte battery are shown in Table 2 and FIGS. 1 and 2.

### Example 1-11

The same procedure as in Example 1-7 was performed except that the solution after the reduction in concentration of fluorine ions was not filtered. Since the amount of generated Li₃FeF₆ was small, the cycle characteristics and high-temperature storage characteristics of the battery were comparable to those in Example 1-7 involving the filtration of the material. The results are shown in Tables 1 and 2 and FIGS. 1 and 2.

### Examples 1-12 and 1-13

In Example 1-12, the same procedure as in Example 1-7 was performed except that LiBF₂(C₂O₄) was further dissolved as a solute at a concentration of 0.5 mol/L, that the concentration of fluorine ions in the initial solution was adjusted to 150 mass ppm, and that Li₂Sn(C₂O₄)₃ was used instead of Li₃Fe(C₂O₄)₃. In Example 1-13, the same procedure as in Example 1-12 was performed except that the molar ratio of fluorine ions in the initial solution to Li₂Sn(C₂O₄)₃ added to the initial solution, fluorine ions: Li₂Sn(C₂O₄)₃, was changed to 1:2.0. The results are shown in Tables 1 and 2 and FIGS. 1 and 2.

### Examples 1-14 to 1-17

In Examples 1-14 and 1-16, the same procedure as in Example 1-12 was performed except that LiBF₄ and LiB(C₂O₄)₂ were respectively used instead of LiBF₂(C₂O₄). In Examples 1-15 and 1-17, the same procedure as in Example 1-13 was performed except that LiBF₄ and LiB(C₂O₄)₂ were respectively used instead of LiBF₂(C₂O₄). The results are shown in Tables 1 and 2 and FIGS. 1 and 2.

### Examples 1-18 and 1-19

In Example 1-18, the same procedure as in Example 1-12 was performed except that LiPF₂(C₂O₄)₂ was used instead of LiBF₂(C₂O₄) and that Li₂Si(C₂O₄)₃ was used instead of Li₂Sn(C₂O₄)₃. In Example 1-19, the same procedure as in Example 1-18 was performed except that the molar ratio of fluorine ions in the initial solution to Li₂Si(C₂O₄)₃ added to the initial solution, fluorine ions:Li₂Si(C₂O₄)₃, was changed to 1:2.0. The results are shown in Tables 1 and 2 and FIGS. 1 and 2.

### Examples 1-20 to 1-23

In Examples 1-20 and 1-22, the same procedure as in Example 1-18 was performed except that LiPO₂F₂ and LiPF₄ (C₂O₄) were respectively used instead of LiPF₂(C₂O₄)₂. In Examples 1-21 and 1-23, the same procedure as in Example 1-19 was performed except that LiPO₂F₂ and LiPF₄(C₂O₄) were respectively used instead of LiPF₂(C₂O₄)₂. The results are shown in Tables 1 and 2 and FIGS. 1 and 2.

### Examples 1-24 and 1-25

In Example 1-24, the same procedure as in Example 1-12 was performed except that LiN(CF₂SO₂)₂ was used instead of LiBF₂(C₂O₄) and that Li₂Ge(C₂O₄)₂ was used instead of Li₂Sn(C₂O₄)₂. In Example 1-25, the same procedure as in Example 1-24 was performed except that the molar ratio of fluorine ions in the initial solution to Li₂Ge(C₂O₄)₂ added to the initial solution, fluorine ions:Li₂Ge(C₂O₄)₂, was changed to 1:2.0. The results are shown in Tables 1 and 2 and FIGS. 1 and 2.

### Examples 1-26 and 1-27

In Example 1-26, the same procedure as in Example 1-12 was performed except that LiN(FSO₂)₂ was used instead of LiBF₂(C₂O₄) and that Li₂Ti(C₂O₄)₂ was used instead of Li₂Sn(C₂O₄)₂. In Example 1-27, the same procedure as in Example 1-26 was performed except that the molar ratio of fluorine ions in the initial solution to Li₂Ti(C₂O₄)₂ added to the initial solution, fluorine ions:Li₂Ti(C₂O₄)₃, was changed to 1:2.0. The results are shown in Tables 1 and 2 and FIGS. 1 and 2.

### Examples 1-28 to 1-30

The concentration of fluorine ions was reduced as in Example 1-1 except that the concentration of fluorine ions in the initial solution and the molar ratio of fluorine ions in the initial solution to Li₃Fe(C₂O₄)₃ added to the initial solution were changed as shown in Table 3. Table 3 shows the filterability of the solution after the reduction in concentration of fluorine ions and the concentrations of Li₃FeF₆, Li₃Fe(C₂O₄)₃ and fluorine ions in the resulting electrolytic solution for a nonaqueous electrolyte battery. The evaluation results of the cycle characteristics and high-temperature storage characteristics of each battery including the electrolytic solution for a nonaqueous electrolyte battery are shown in Table 4 and FIGS. 1 and 2.

TABLE 3

| | | | | | | | | Electrolytic solution for a nonaqueous | | |
|---|---|---|---|---|---|---|---|---|---|---|
| | | | | | Salt or | | | electrolyte battery | | |
| | | | Concentration | | oxide of | Fluorine | Filter- | Concen- | Concen- | Concentration |
| | Nonaqueous | | of fluorine | | metal | ion:oxalato | ability | tration of | tration | of fluorine ions |
| | electrolytic | | ions in initial | | other | salt in initial | [kg/ | hexafluoro | of oxalato | at about 1 hr |
| | solution | | solution | Oxalato | than | solution | (m² · | salt [mass | salt [mass | after filtration |
| | No. | Solute | [mass ppm] | salt | lithium | [molar ratio] | sec)] | ppm] | ppm] | [mass ppm] |
| Example 1-28 | 1-28 | LiPF₆ | 200 | Li₃Fe(C₂O₄)₃ | None | 1:0.2 | 3 | 142 | 106 | 7 |
| Example 1-29 | 1-29 | | 200 | | | 1:1.0 | 3 | 123 | 2921 | 9 |
| Example 1-30 | 1-30 | | 200 | | | 1:2.0 | 4 | 121 | 6430 | 8 |
| Example 1-31 | 1-31 | | 300 | | | 1:0.2 | 0.05 | 139 | 163 | 6 |
| Example 1-32 | 1-32 | | 300 | | | 1:1.0 | 0.05 | 121 | 4381 | 9 |
| Example 1-33 | 1-33 | | 400 | | | 1:0.2 | 0.03 | 131 | 216 | 10 |
| Example 1-34 | 1-34 | | 400 | | | 1:1.0 | 0.02 | 112 | 5838 | 8 |
| Example 1-35 | 1-35 | | 100 | Li₃FeF₂(C₂O₄)₂ | | 1:0.5 | 4 | 135 | 373 | 5 |
| Example 1-36 | 1-36 | | 100 | Li₃FeF₄(C₂O₄) | | 1:0.8 | 4 | 132 | 375 | 5 |

TABLE 4

| | Nonaqueous | | | | |
|---|---|---|---|---|---|
| | electrolytic solution | Cathode active | Anode active | Discharge capacity retention rate | Discharge capacity retention rate |
| | No. | material | material | after 500 cycles [%] | after 10 days storage [%] |
| Example 1-28 | 1-28 | LiCoO₂ | Graphite | 75 | 59 |
| Example 1-29 | 1-29 | | | 76 | 61 |
| Example 1-30 | 1-30 | | | 76 | 60 |
| Example 1-31 | 1-31 | | | 77 | 58 |
| Example 1-32 | 1-32 | | | 76 | 59 |
| Example 1-33 | 1-33 | | | 75 | 60 |
| Example 1-34 | 1-34 | | | 77 | 61 |
| Example 1-35 | 1-35 | | | 75 | 60 |
| Example 1-36 | 1-36 | | | 76 | 61 |

### Examples 1-31 and 1-32

In Example 1-31, the same procedure as in Example 1-7 was performed except that the concentration of fluorine ions in the initial solution was adjusted to 300 mass ppm. In Example 1-32, the same procedure as in Example 1-31 was performed except that the molar ratio of fluorine ions in the initial solution to Li₃Fe(C₂O₄)₃ added to the initial solution, fluorine ions:Li₃Fe(C₂O₄)₃, was changed to 1:1.0. The results are shown in Tables 3 and 4 and FIGS. 1 and 2.

### Examples 1-33 and 1-34

In Example 1-33, the same procedure as in Example 1-7 was performed except that the concentration of fluorine ions in the initial solution was adjusted to 400 mass ppm. In Example 1-34, the same procedure as in Example 1-33 was performed except that the molar ratio of fluorine ions in the initial solution to Li₃Fe(C₂O₄)₃ added to the initial solution, fluorine ions:Li₃Fe(C₂O₄)₃, was changed to 1:1.0. The results are shown in Tables 3 and 4 and FIGS. 1 and 2.

### Examples 1-35 and 1-36

The concentration of fluorine ions was reduced as in Example 1-1 except that the concentration of fluorine ions in the initial solution, the type of the oxalato salt, and the molar ratio of fluorine ions in the initial solution to the oxalato salt added to the initial solution were changed as shown in Table 3. The results are shown in Tables 3 and 4 and FIGS. 1 and 2.

### Examples 1-37 to 1-66

In Examples 1-37 to 1-53, the concentrations of fluorine ions were reduced as in Examples 1-1 to 1-17, respectively, except that Li₂Si(C₂O₄)₃ was used as the oxalato salt. In Examples 1-54 to 1-64, the concentrations of fluorine ions were reduced as in Examples 1-24 to 1-34, respectively, except that Li₂Si(C₂O₄)₃ was used as the oxalato salt. In Example 1-65, the concentration of fluorine ions was reduced as in Example 1-35 except that Li₂SiF₂(C₂O₄)₂ was used as the oxalato salt. In Example 1-66, the concentration of fluorine ions was reduced as in Example 1-36 except that Li₂SiF₄(C₂O₄) was used as the oxalato salt. The results are shown in Tables 5 and 6 and FIGS. 1 and 2.

TABLE 5

| | | | | | | | | Electrolytic solution for a nonaqueous | | |
|---|---|---|---|---|---|---|---|---|---|---|
| | Non- | | Concen- | | Salt or | | | electrolyte battery | | |
| | aqueous | | tration | | oxide of | Fluorine | Filter- | Concen- | Concen- | Concentration |
| | electro- | | of fluorine | | metal | ion:oxalato | ability | tration of | tration | of fluorine ions |
| | lytic | | ions in initial | | other | salt in initial | [kg/ | hexafluoro | of oxalato | at about 1 hr |
| | solution | | solution | Oxalato | than | solution | (m² · | salt [mass | salt | after filtration |
| | No. | Solute | [mass ppm] | salt | lithium | [molar ratio] | sec)] | ppm] | [mass ppm] | [mass ppm] |
| Example 1-37 | 1-37 | LiPF₆ | 30 | Li₂Si(C₂O₄)₃ | None | 1:0.01 | 3 | 2 | N.D. | 27 |
| Example 1-38 | 1-38 | | 30 | | | 1:0.02 | 9 | 4 | N.D. | 26 |
| Example 1-39 | 1-39 | | 30 | | | 1:0.2 | 9 | 39 | 15 | 7 |
| Example 1-40 | 1-40 | | 50 | | | 1:0.02 | 9 | 8 | N.D. | 45 |
| Example 1-41 | 1-41 | | 50 | | | 1:0.2 | 9 | 67 | 25 | 6 |
| Example 1-42 | 1-42 | | 50 | | | 1:2.0 | 9 | 68 | 1476 | 8 |
| Example 1-43 | 1-43 | | 100 | | | 1:0.2 | 7 | 135 | 51 | 7 |
| Example 1-44 | 1-44 | | 100 | | | 1:1.0 | 6 | 131 | 1342 | 7 |
| Example 1-45 | 1-45 | | 100 | | | 1:2.0 | 7 | 126 | 2958 | 9 |
| Example 1-46 | 1-46 | | 100 | | | 1:3.0 | 5 | 121 | 4563 | 8 |
| Example 1-47 | 1-47 | | 100 | | | 1:0.2 | — | 138 | 54 | 7 |
| Example 1-48 | 1-48 | LiPF₆, | 150 | | | 1:0.2 | 8 | 136 | 82 | 8 |
| Example 1-49 | 1-49 | LiBF₂(C₂O₄) | 150 | | | 1:2.0 | 8 | 120 | 4431 | 8 |
| Example 1-50 | 1-50 | LiPF₆, | 150 | | | 1:0.2 | 8 | 135 | 80 | 9 |
| Example 1-51 | 1-51 | LiBF₄ | 150 | | | 1:2.0 | 7 | 115 | 4427 | 7 |
| Example 1-52 | 1-52 | LiPF₆, | 150 | | | 1:0.2 | 8 | 134 | 82 | 9 |
| Example 1-53 | 1-53 | LiB(C₂O₄)₂ | 150 | | | 1:2.0 | 7 | 118 | 4429 | 7 |
| Example 1-54 | 1-54 | LiPF₆, | 150 | | | 1:0.2 | 7 | 137 | 81 | 8 |
| Example 1-55 | 1-55 | LiN(CF₃SO₂)₂ | 150 | | | 1:2.0 | 6 | 119 | 4435 | 8 |
| Example 1-56 | 1-56 | LiPF₆, | 150 | | | 1:0.2 | 7 | 136 | 82 | 9 |
| Example 1-57 | 1-57 | LiN(FSO₂)₂ | 150 | | | 1:2.0 | 6 | 120 | 4425 | 9 |
| Example 1-58 | 1-58 | LiPF₆ | 200 | | | 1:0.2 | 4 | 131 | 101 | 8 |
| Example 1-59 | 1-59 | | 200 | | | 1:1.0 | 3 | 126 | 2681 | 7 |
| Example 1-60 | 1-60 | | 200 | | | 1:2.0 | 3 | 123 | 5908 | 8 |
| Example 1-61 | 1-61 | | 300 | | | 1:0.2 | 0.05 | 131 | 157 | 9 |
| Example 1-62 | 1-62 | | 300 | | | 1:1.0 | 0.04 | 116 | 4023 | 10 |
| Example 1-63 | 1-63 | | 400 | | | 1:0.2 | 0.04 | 132 | 212 | 9 |
| Example 1-64 | 1-64 | | 400 | | | 1:1.0 | 0.02 | 113 | 5368 | 10 |
| Example 1-65 | 1-65 | | 100 | Li₂SiF₂(C₂O₄)₂ | | 1:0.5 | 5 | 134 | 273 | 6 |
| Example 1-66 | 1-66 | | 100 | Li₂SiF₄(C₂O₄) | | 1:0.8 | 4 | 131 | 405 | 5 |

TABLE 6

| | Nonaqueous | Cathode | Anode | Discharge capacity | Discharge capacity retention |
|---|---|---|---|---|---|
| | electrolytic solution | active | active | retention rate after 500 | rate after 10 days storage |
| | No. | material | material | cycles [%] | [%] |
| Example 1-37 | 1-37 | LiCoO₂ | Graphite | 74 | 53 |
| Example 1-38 | 1-38 | | | 75 | 53 |
| Example 1-39 | 1-39 | | | 77 | 58 |
| Example 1-40 | 1-40 | | | 72 | 54 |
| Example 1-41 | 1-41 | | | 77 | 61 |
| Example 1-42 | 1-42 | | | 76 | 60 |
| Example 1-43 | 1-43 | | | 78 | 60 |
| Example 1-44 | 1-44 | | | 76 | 61 |
| Example 1-45 | 1-45 | | | 75 | 63 |
| Example 1-46 | 1-46 | | | 77 | 61 |
| Example 1-47 | 1-47 | | | 78 | 62 |
| Example 1-48 | 1-48 | | | 87 | 74 |
| Example 1-49 | 1-49 | | | 86 | 75 |
| Example 1-50 | 1-50 | | | 84 | 73 |
| Example 1-51 | 1-51 | | | 84 | 72 |
| Example 1-52 | 1-52 | | | 89 | 77 |
| Example 1-53 | 1-53 | | | 88 | 78 |
| Example 1-54 | 1-54 | | | 84 | 76 |
| Example 1-55 | 1-55 | | | 85 | 75 |
| Example 1-56 | 1-56 | | | 83 | 74 |
| Example 1-57 | 1-57 | | | 84 | 75 |
| Example 1-58 | 1-58 | | | 76 | 61 |
| Example 1-59 | 1-59 | | | 77 | 60 |
| Example 1-60 | 1-60 | | | 77 | 61 |
| Example 1-61 | 1-61 | | | 76 | 58 |
| Example 1-62 | 1-62 | | | 75 | 58 |
| Example 1-63 | 1-63 | | | 74 | 59 |
| Example 1-64 | 1-64 | | | 75 | 58 |
| Example 1-65 | 1-65 | | | 77 | 61 |
| Example 1-66 | 1-66 | | | 78 | 62 |

### Comparative Example 1-1

The same procedure as in Example 1-7 was performed except that no oxalato salt was added. The concentration of fluorine ions in the resulting electrolytic solution for a nonaqueous electrolyte battery was still 100 mass ppm and was thus not reduced. The cycle characteristics, i.e., the discharge capacity retention rate after 500 cycles at 60° C., of the battery including the electrolytic solution for a nonaqueous electrolyte battery were low. Thus, deterioration of the cell was observed. In addition, the high-temperature storage characteristics, i.e., the discharge capacity retention rate after 10 days storage at 60° C., were low. Thus, deterioration of the cell was observed. The results are shown in Tables 7 and 8 and FIGS. 1 and 2.

TABLE 7

| | | | Concen- | | | | | Electrolytic solution for a nonaqueous | | |
|---|---|---|---|---|---|---|---|---|---|---|
| | | | tration of | | | Fluorine | | electrolyte battery | | |
| | | | fluorine | | | ion:oxalato | | Concen- | Concen- | Concentration |
| | | | ions in | | Salt or | salt in | | tration | tration of | of |
| | Nonaqueous | | initial | | oxide of | initial | | of | oxalato | fluorine ions at |
| | electrolytic | | solution | | metal | solution | Filterability | hexafluoro | salt | about 1 hr after |
| | solution | | [mass | | other than | [molar | [kg/(m² · | salt | [mass | filtration [mass |
| | No. | Solute | ppm] | Oxalato salt | lithium | ratio] | sec)] | [mass ppm] | ppm] | ppm] |
| Comparative | 1-67 | LiPF₆ | 100 | None | None | — | 9 | — | — | 100 |
| Example 1-1 | | | | | | | | | | |
| Comparative | 1-68 | | 100 | Li₃Fe(C₂O₄)₃ | | 1:20 | 1 | 147 | 34852 | 6 |
| Example 1-2 | | | | | | | | | | |
| Comparative | 1-69 | | 100 | Li₂Si(C₂O₄)₃ | | 1:20 | 1 | 142 | 31942 | 7 |
| Example 1-3 | | | | | | | | | | |
| Comparative | 1-70 | | 100 | None | Ca(NO₃)₂ | — | 3 | — | — | 19 |
| Example 1-4 | | | | | | | | | | |
| Comparative | 1-71 | | 100 | | MgSO₄ | — | 0.5 | — | — | 16 |
| Example 1-5 | | | | | | | | | | |
| Comparative | 1-72 | | 100 | | BaO | — | 0.5 | — | — | 21 |
| Example 1-6 | | | | | | | | | | |

TABLE 8

| | Nonaqueous | | | Discharge capacity | Discharge capacity retention |
|---|---|---|---|---|---|
| | electrolytic solution | Cathode active | Anode active | retention rate after 500 | rate after 10 days storage |
| | No. | material | material | cycles [%] | [%] |
| Comparative | 1-67 | LiCoO₂ | Graphite | 58 | 43 |
| Example 1-1 | | | | | |
| Comparative | 1-68 | | | 67 | 47 |
| Example 1-2 | | | | | |
| Comparative | 1-69 | | | 66 | 48 |
| Example 1-3 | | | | | |
| Comparative | 1-70 | | | 61 | 42 |
| Example 1-4 | | | | | |
| Comparative | 1-71 | | | 59 | 43 |
| Example 1-5 | | | | | |
| Comparative | 1-72 | | | 54 | 39 |
| Example 1-6 | | | | | |

### Comparative Example 1-2

The same procedure as in Example 1-7 was performed except that the molar ratio of fluorine ions in the initial solution to Li₃Fe(C₂O₄)₃ added to the initial solution, fluorine ions:Li₃Fe(C₂O₄)₃, was changed to 1:20. Although the concentration of fluorine ions in the resulting electrolytic solution for a nonaqueous electrolyte battery was reduced to 50 mass ppm or less, the concentration of Li₃Fe(C₂O₄)₃ was, 34852 mass ppm, higher than 6500 mass ppm. The cycle characteristics and high-temperature storage characteristics of the battery including the electrolytic solution for a nonaqueous electrolyte battery were low. Thus, deterioration of the cell was observed. The results are shown in Tables 7 and 8 and FIGS. 1 and 2.

### Comparative Example 1-3

The same procedure as in Comparative Example 1-2 was performed except that Li₃Si(C₂O₄)₃ was used as the oxalato salt instead of Li₃Fe(C₂O₄)₃. Although the concentration of fluorine ions in the resulting electrolytic solution for a nonaqueous electrolyte battery was reduced to 50 mass ppm or less, the concentration of Li₂Si(C₂O₄)₃ was, 31942 mass ppm, higher than 6500 mass ppm. The cycle characteristics and high-temperature storage characteristics of the battery including the electrolytic solution for a nonaqueous electrolyte battery were low. Thus, deterioration of the cell was observed. The results are shown in Tables 7 and 8 and FIGS. 1 and 2.

### Comparative Example 1-4

The same procedure as in Example 1-7 was performed except that Ca(NO₃)₂ was added to the initial solution as a salt or oxide of a metal other than lithium instead of addition of the oxalato salt and that the molar ratio of fluorine ions in the initial solution to Ca(NO₃)₂ added to the initial solution, fluorine ions:Ca(NO₃)₂, was 1:0.5. Although the concentration of fluorine ions in the resulting electrolytic solution for a nonaqueous electrolyte battery was reduced to 50 mass ppm or less, the cycle characteristics and high-temperature storage characteristics of the battery including the electrolytic solution for a nonaqueous electrolyte battery were low. Thus, deterioration of the cell was observed. It has been believed that the deterioration was caused by the inside of the battery system contaminated with the metal ions other than lithium, i.e., calcium ions, to cause an irreversible reaction inside the battery. The results are shown in Tables 7 and 8 and FIGS. 1 and 2.

### Comparative Example 1-5

The same procedure as in Example 1-7 was performed except that MgSO₄ was added to the initial solution as a salt or oxide of a metal other than lithium instead of addition of the oxalato salt and that the molar ratio of fluorine ions in the initial solution to MgSO₄ added to the initial solution, fluorine ions:MgSO₄, was 1:0.5. Although the concentration of fluorine ions in the resulting electrolytic solution for a nonaqueous electrolyte battery was reduced to 50 mass ppm or less, the cycle characteristics and high-temperature storage characteristics of the battery including the electrolytic solution for a nonaqueous electrolyte battery were low. Thus, deterioration of the cell was observed. It has been believed that the deterioration was caused by the inside of the battery system contaminated with the metal ions other than lithium, i.e., magnesium ions, to cause an irreversible reaction inside the battery. The results are shown in Tables 7 and 8 and FIGS. 1 and 2.

### Comparative Example 1-6

The same procedure as in Example 1-7 was performed except that BaO was added to the initial solution as a salt or oxide of a metal other than lithium instead of addition of the oxalato salt and that the molar ratio of fluorine ions in the initial solution to BaO added to the initial solution, fluorine ions: BaO, was 1:0.5. Although the concentration of fluorine ions in the resulting electrolytic solution for a nonaqueous electrolyte battery was reduced to 50 mass ppm or less and the concentration of fluorine ions in the electrolytic solution for a nonaqueous electrolyte battery at about 1 hour after the filtration was 21 mass ppm, the amount of moisture in the electrolytic solution for a nonaqueous electrolyte battery was, 54 mass ppm, high. In addition, the concentration of fluorine ions in the electrolytic solution for a nonaqueous electrolyte battery at about 24 hours after the filtration was, 108 mass ppm, further increased, and the amount of moisture in the electrolytic solution for a nonaqueous electrolyte battery was 6 mass ppm. It was believed that the deterioration was caused by the electrolyte hydrolyzed by the moisture to generate hydrogen fluoride inside the battery and the inside of the battery system contaminated with the metal ions other than lithium, i.e., barium ions, to cause an irreversible reaction inside the battery. The cycle characteristics and high-temperature storage characteristics of the battery including the electrolytic solution for a nonaqueous electrolyte battery were low. Thus, deterioration of the cell was observed. The results are shown in Tables 7 and 8 and FIGS. 1 and 2.

### Examples 1-67 to 1-74 and Comparative Examples 1-7 to 1-10

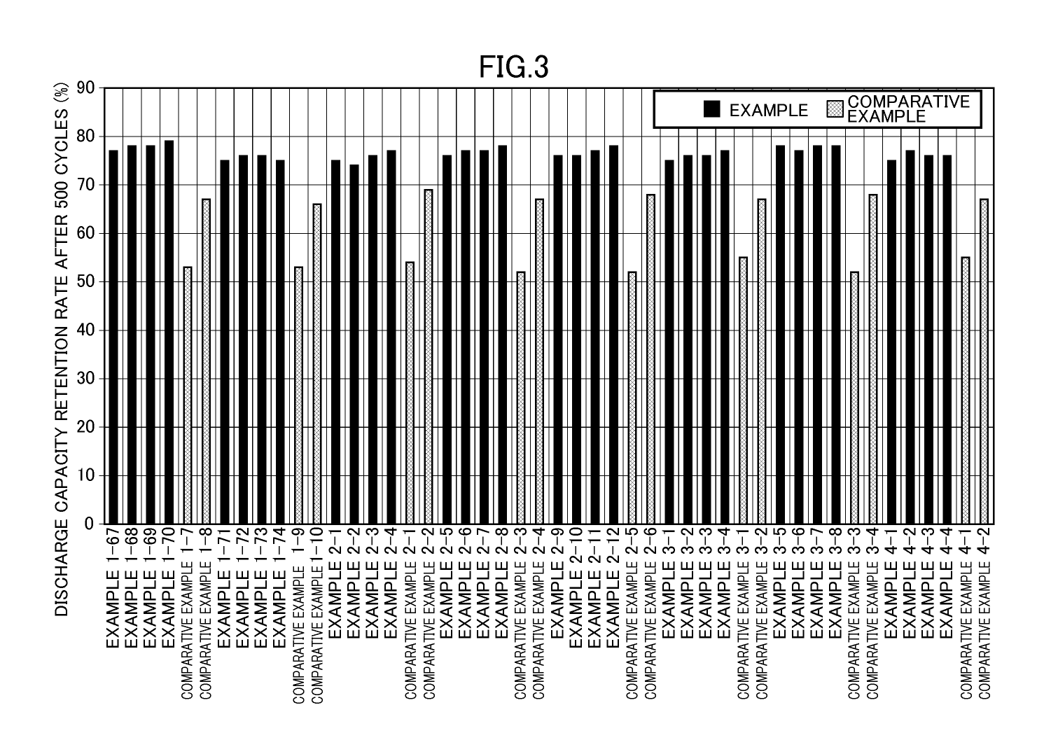

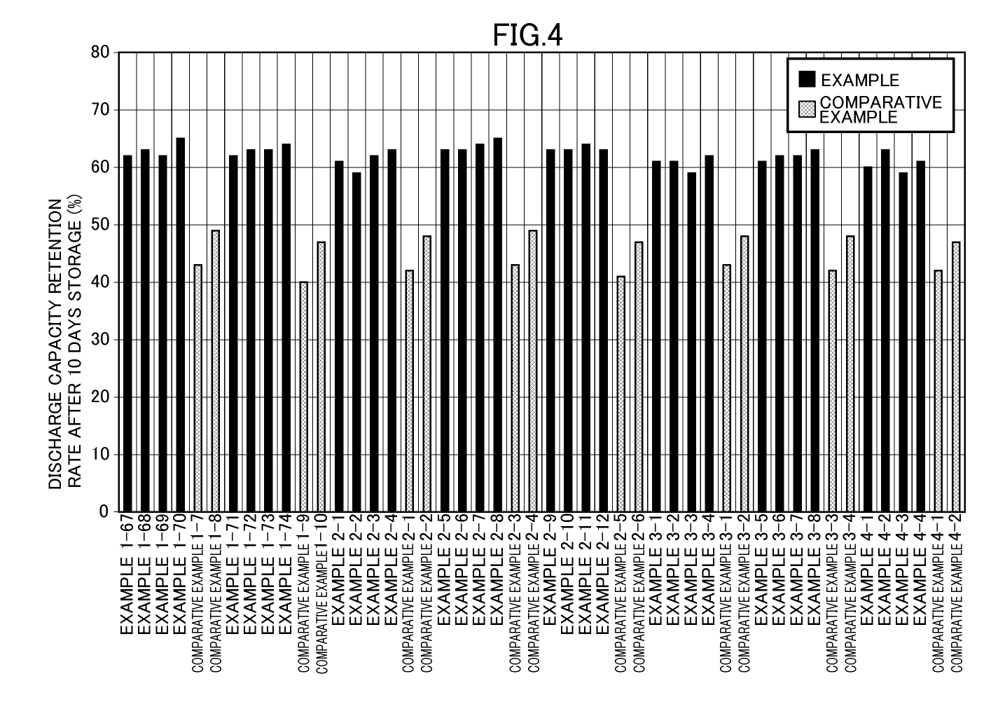

The cycle characteristics and high-temperature storage characteristics of each battery were evaluated by changing the anode body used in Example 1-1 and using any of nonaqueous electrolytic solution Nos. 1-7 to 1-9, 1-44, 1-67 and 1-69 as the electrolytic solution for a nonaqueous electrolyte battery. In Examples 1-67 to 1-70 and Comparative Examples 1-7 and 1-8 using Li₄Ti₅O₁₂ as the anode active material, the anode body was produced by mixing 90% by mass of Li₄Ti₅O₁₂ powder with 5% by mass of polyvinylidene fluoride (PVDF) as a binder and 5% by mass of acetylene black as a conductive material, further adding N-methylpyrrolidone to the mixture, applying the resulting paste onto copper foil, and drying the applied paste. The battery was evaluated at a charge termination voltage of 2.7 V and a discharge termination voltage of 1.5 V. In Examples 1-71 to 1-74 and Comparative Examples 1-9 and 1-10 using silicon (simple substance) as the anode active material, the anode body was produced by mixing 80% by mass of a silicon powder with 5% by mass of polyvinylidene fluoride (PVDF) as a binder and 15% by mass of acetylene black as a conductive material, further adding N-methylpyrrolidone to the mixture, applying the resulting paste onto copper foil, and drying the applied paste. Each battery was evaluated at the same charge termination voltage and discharge termination voltage as those in Example 1-1. The evaluation results of cycle characteristics and high-temperature storage characteristics of each battery are shown in Table 9 and FIGS. 3 and 4.

TABLE 9

| | | | | Discharge | Discharge |
|---|---|---|---|---|---|
| | Nonaqueous | | | capacity | capacity |
| | electrolytic | Cathode | Anode | retention | retention rate |
| | solution | active | active | rate after 500 | after 10 days |
| | No. | material | material | cycles [%] | storage [%] |
| Example 1-67 | 1-7 | LiCoO₂ | Li₄Ti₅O₁₂ | 77 | 62 |
| Example 1-68 | 1-8 | | | 78 | 63 |
| Example 1-69 | 1-9 | | | 78 | 62 |
| Example 1-70 | 1-44 | | | 79 | 65 |
| Comparative | 1-67 | | | 53 | 43 |
| Example 1-7 | | | | | |
| Comparative | 1-69 | | | 67 | 49 |
| Example 1-8 | | | | | |
| Example 1-71 | 1-7 | | silicon | 75 | 62 |
| Example 1-72 | 1-8 | | (simple | 76 | 63 |
| Example 1-73 | 1-9 | | substance) | 76 | 63 |
| Example 1-74 | 1-44 | | | 75 | 64 |
| Comparative | 1-67 | | | 53 | 40 |
| Example 1-9 | | | | | |
| Comparative | 1-69 | | | 66 | 47 |
| Example 1-10 | | | | | |
| Example 2-1 | 1-7 | LiNi_{1/3}Mn_{1/3}Co_{1/3}O₂ | graphite | 75 | 61 |
| Example 2-2 | 1-8 | | | 74 | 59 |
| Example 2-3 | 1-9 | | | 76 | 62 |
| Example 2-4 | 1-44 | | | 77 | 63 |
| Comparative | 1-67 | | | 54 | 42 |
| Example 2-1 | | | | | |
| Comparative | 1-69 | | | 69 | 48 |
| Example 2-2 | | | | | |
| Example 2-5 | 1-7 | | Li₄Ti₅O₁₂ | 76 | 63 |
| Example 2-6 | 1-8 | | | 77 | 63 |
| Example 2-7 | 1-9 | | | 77 | 64 |
| Example 2-8 | 1-44 | | | 78 | 65 |
| Comparative | 1-67 | | | 52 | 43 |
| Example 2-3 | | | | | |
| Comparative | 1-69 | | | 67 | 49 |
| Example 2-4 | | | | | |
| Example 2-9 | 1-7 | | silicon | 76 | 63 |
| Example 2-10 | 1-8 | | (simple | 76 | 63 |
| Example 2-11 | 1-9 | | substance) | 77 | 64 |
| Example 2-12 | 1-44 | | | 78 | 63 |
| Comparative | 1-67 | | | 52 | 41 |
| Example 2-5 | | | | | |
| Comparative | 1-69 | | | 68 | 47 |
| Example 2-6 | | | | | |
| Example 3-1 | 1-7 | LiMn_{1.95}Al_{0.05}O₄ | graphite | 75 | 61 |
| Example 3-2 | 1-8 | | | 76 | 61 |
| Example 3-3 | 1-9 | | | 76 | 59 |
| Example 3-4 | 1-44 | | | 77 | 62 |
| Comparative | 1-67 | | | 55 | 43 |
| Example 3-1 | | | | | |
| Comparative | 1-69 | | | 67 | 48 |
| Example 3-2 | | | | | |
| Example 3-5 | 1-7 | | Li₄Ti₅O₁₂ | 78 | 61 |
| Example 3-6 | 1-8 | | | 77 | 62 |
| Example 3-7 | 1-9 | | | 78 | 62 |
| Example 3-8 | 1-44 | | | 78 | 63 |
| Comparative | 1-67 | | | 52 | 42 |
| Example 3-3 | | | | | |
| Comparative | 1-69 | | | 68 | 48 |
| Example 3-4 | | | | | |
| Example 4-1 | 1-7 | LiFePO₄ | graphite | 75 | 60 |
| Example 4-2 | 1-8 | | | 77 | 63 |
| Example 4-3 | 1-9 | | | 76 | 59 |
| Example 4-4 | 1-44 | | | 76 | 61 |
| Comparative | 1-67 | | | 55 | 42 |
| Example 4-1 | | | | | |
| Comparative | 1-69 | | | 67 | 47 |
| Example 4-2 | | | | | |

### Examples 2-1 to 2-12 and Comparative Examples 2-1 to 2-6

The cycle characteristics and high-temperature storage characteristics of each battery were evaluated by changing the anode body and cathode body used in Example 1-1 and using any of nonaqueous electrolytic solution Nos. 1-7 to 1-9, 1-44, 1-67, and 1-69 as the electrolytic solution for a nonaqueous electrolyte battery. The cathode body of which cathode active material was LiNi_{1/3}Mn_{1/3}Co_{1/3}O₂ was produced by mixing 90% by mass of LiNi_{1/3}Mn_{1/3}Co_{1/3}O₂ powder with 5% by mass of polyvinylidene fluoride (PVDF) as a binder and 5% by mass of acetylene black as a conductive material, further adding N-methylpyrrolidone to the mixture, applying the resulting paste onto aluminum foil, and drying the applied paste. In Examples 2-1 to 2-4 and Comparative Examples 2-1 and 2-2 using graphite as the anode active material as in Example 1-1, each battery was evaluated at a charge termination voltage of 4.3 V and a discharge termination voltage of 3.0 V. In Examples 2-5 to 2-8 and Comparative Examples 2-3 and 2-4 using Li₄Ti₅O₁₂ as the anode active material as in Example 1-67, each battery was evaluated at a charge termination voltage of 2.8 V and a discharge termination voltage of 1.5 V. In Examples 2-9 to 2-12 and Comparative Examples 2-5 and 2-6 using silicon (simple substance) as the anode active material as in Example 1-71, each battery was evaluated at a charge termination voltage of 4.3 V and a discharge termination voltage of 3.0 V. The evaluation results of the cycle characteristics and high-temperature storage characteristics of each battery are shown in Table 9 and FIGS. 3 and 4.

### Examples 3-1 to 3-8 and Comparative Examples 3-1 to 3-4

The cycle characteristics and high-temperature storage characteristics of each battery were evaluated by changing the anode body and cathode body used in Example 1-1 and using any of nonaqueous electrolytic solution Nos. 1-7 to 1-9, 1-44, 1-67 and 1-69 as the electrolytic solution for a nonaqueous electrolyte battery. The cathode body of which cathode active material was LiMn_{1.95}Al_{0.05}O₄ was produced by mixing 90% by mass of LiMn_{1.95}Al_{0.05}O₄ powder with 5% by mass of polyvinylidene fluoride (PVDF) as a binder and 5% by mass of acetylene black as a conductive material, further adding N-methylpyrrolidone to the mixture, applying the resulting paste onto aluminum foil, and drying the applied paste. In Examples 3-1 to 3-4 and Comparative Examples 3-1 and 3-2 using graphite as the anode active material as in Example 1-1, each battery was evaluated at the same charge termination voltage and discharge termination voltage as those in Example 1-1. In Examples 3-5 to 3-8 and Comparative Examples 3-3 and 3-4 using Li₄Ti₅O₁₂ as the anode active material as in Example 1-67, each battery was evaluated at a charge termination voltage of 2.7 V and a discharge termination voltage of 1.5 V. The evaluation results of the cycle characteristics and high-temperature storage characteristics of each battery are shown in Table 9 and FIGS. 3 and 4.

### Examples 4-1 to 4-4 and Comparative Examples 4-1 and 4-2

The cycle characteristics and high-temperature storage characteristics of each battery were evaluated by changing the cathode body used in Example 1-1 and using any of nonaqueous electrolytic solution Nos. 1-7 to 1-9, 1-44, 1-67 and 1-69 as the electrolytic solution for a nonaqueous electrolyte battery. The cathode body of which cathode active material was LiFePO₄ was produced by mixing 90% by mass of LiFePO₄ powder coated with amorphous carbon with 5% by mass of polyvinylidene fluoride (PVDF) as a binder and 5% by mass of acetylene black as a conductive material, further adding N-methylpyrrolidone to the mixture, applying the resulting paste onto aluminum foil, and drying the applied paste. The evaluation results of the cycle characteristics and high-temperature storage characteristics of each battery at a charge termination voltage of 3.6 V and a discharge termination voltage of 2.0 V are shown in Table 9 and FIGS. 3 and 4.

As described above, it was confirmed that the cycle characteristics and high-temperature storage characteristics of the laminate cells including the electrolytic solution for a nonaqueous electrolyte battery of the present invention were excellent in the Examples using LiNi_{1/3}Mn_{1/3}Co_{1/3}O₂, LiMn_{1.95}Al_{0.05}O₄, or LiFePO₄ as the cathode active material, compared with the corresponding Comparative Examples. It was thus demonstrated that a nonaqueous electrolyte battery having excellent cycle characteristics and high-temperature storage characteristics can be obtained by using the electrolytic solution for a nonaqueous electrolyte battery of the present invention, regardless of the type of the cathode active material.

In addition, as described above, it was confirmed that the cycle characteristics and high-temperature storage characteristics of the laminate cells including the electrolytic solution for a nonaqueous electrolyte battery of the present invention were excellent in the Examples using Li₄Ti₅O₁₂ or silicon (simple substance) as the anode active material, compared with the corresponding Comparative Examples. It was thus demonstrated that a nonaqueous electrolyte battery having excellent cycle characteristics and high-temperature storage characteristics can be obtained by using the electrolytic solution for a nonaqueous electrolyte battery of the present invention, regardless of the type of the anode active material.

1. An electrolytic solution for a nonaqueous battery comprising a nonaqueous solvent and at least one fluorine-containing lithium salt as a solute,
wherein an oxalato salt represented by Formula (1) below is further added to the solution,
wherein the content of a hexafluoro salt represented by Formula (2) below is 150 mass ppm or less;
LiₓMF_{(6-2y)}(C₂O₄)_{y} (1)
LiₓMF₆ (2)
wherein M represents Fe, Sn, Si, Ge or Ti; x is 3 when M is Fe, and 2 when M is Sn, Si, Ge or Ti; and y is an integer of 1 to 3, and
wherein the content of the oxalato salt is 6500 mass ppm or less; and further
wherein the content of free fluorine ions is 50 mass ppm or less.

2. The electrolytic solution according to claim 1, wherein the oxalato salt is at least one tris(oxalato) compound selected from the group consisting of Li₃Fe(C₂O₄)₃, Li₂Sn(C₂O₄)₃, Li₂Si(C₂O₄)₃, Li₂Ge(C₂O₄)₃ and Li₂Ti(C₂O₄)₃.

3. The electrolytic solution according to claim 1, wherein the solute is at least one lithium salt selected from the group consisting of lithium hexafluorophosphate (LiPF₆), lithium tetrafluoroborate (LiBF₄), lithium bis(trifluoromethanesulfonyl)imide (LiN(CF₃SO₂)₂), lithium bis(fluorosulfonyl)imide (LiN(FSO₂)₂), lithium bis(pentafluoroethanesulfonyl)imide (LiN(C₂F₅SO₂)₂), lithium difluoro(oxalato)borate (LiBF₂(C₂O₄)), lithium difluoro(bis(oxalato))phosphate (LiPF₂(C₂O₄)₂), lithium tetrafluoro(oxalato)phosphate (LiPF₄(C₂O₄)) and lithium difluorophosphate (LiPO₂F₂).

4. The electrolytic solution according to claim 1, wherein the nonaqueous solvent is at least one nonaqueous solvent selected from the group consisting of cyclic carbonates, chain carbonates, cyclic esters, chain esters, cyclic ethers, chain ethers, sulfur-containing nonaqueous solvents and ion liquids.

5. A nonaqueous electrolyte battery comprising at least a cathode, an anode and an electrolytic solution for a nonaqueous electrolyte battery comprising a nonaqueous solvent and at least one fluorine-containing lithium salt as a solute, wherein said electrolytic solution for a nonaqueous electrolyte battery is the electrolytic solution according to claim 1.

6. A method for producing an electrolytic solution for a nonaqueous electrolyte battery according to claim 1, comprising the steps of:
preparing a solution containing 200 mass ppm or less of free fluorine ions by dissolving at least one fluorine-containing lithium salt as a solute in a nonaqueous solvent; and
reacting the free fluorine ions in the solution with an oxalato salt represented by Formula (1) by adding the oxalato salt to the solution.

7. The method according to claim 6, wherein the oxalato salt is added to the solution at a molar ratio of the oxalato salt to the free fluorine ions of 0.02 to 2.0.

8. The method according to claim 6, further comprising the step of:
removing the solid content of a reaction product by filtration.

9. The method according to claim 6, wherein the oxalato salt is at least one tris(oxalato) compound selected from the group consisting of Li₃Fe(C₂O₄)₃, Li₂Sn(C₂O₄)₃, Li₂Si(C₂O₄)₃, Li₂Ge(C₂O₄)₃ and Li₂Ti(C₂O₄)₃.

10. The method according to claim 6, wherein the solute is at least one lithium salt selected from the group consisting of lithium hexafluorophosphate (LiPF₆), lithium tetrafluoroborate (LiBF₄), lithium bis(trifluoromethanesulfonyl)imide (LiN(CF₃SO₂)₂), lithium bis(fluorosulfonyl)imide (LiN(FSO₂)₂), lithium bis(pentafluoroethanesulfonyl)imide (LiN(C₂F₅SO₂)₂), lithium difluoro(oxalato)borate (LiBF₂(C₂O₄)), lithium difluoro(bis(oxalato))phosphate (LiPF₂(C₂O₄)₂), lithium tetrafluoro(oxalato)phosphate (LiPF₄(C₂O₄)) and lithium difluorophosphate (LiPO₂F₂).

11. The method according to claim 6, wherein said nonaqueous solvent is at least one nonaqueous solvent selected from the group consisting of cyclic carbonates, chain carbonates, cyclic esters, chain esters, cyclic ethers, chain ethers, sulfur-containing nonaqueous solvents and ion liquids.
